(19) United States
(12) Patent Application Publication
(10) Pub. No.: US 2014/0086519 A1
(43) Pub. Date: Mar. 27, 2014

(54) ANTI-FRICTION BEARING, IN PARTICULAR TWO-ROW ANTI-FRICTION BEARING, HAVING A POWER GENERATION UNIT, IN PARTICULAR FOR MOUNTING A ROLLER

(71) Applicant: Schaeffler Technologies AG & Co. KG, Herzogenaurach (DE)

(72) Inventors: Thomas Rink, Waldfenster (DE); Werner Roman, Kressberg (DE); Heinz Theumer, Niederwerrn (DE); Martin Grehn, Dittelbrunn (DE); Henri van der Knokke, Buchs (CH); Karl Muller, Grettstadt (DE)

(73) Assignee: Schaeffler Technologies AG & Co. KG, Herzogenaurach (DE)

(21) Appl. No.: 14/116,609

(22) PCT Filed: Apr. 17, 2012
(86) PCT No.: PCT/EP2012/056952

§ 371 Date: Nov. 8, 2013

(30) Foreign Application Priority Data
May 10, 2011 (DE) 10 2011 075 547.0

(51) Int. Cl. F16C 23/08

(52) U.S. Cl. CPC F16C 23/086
USPC 384/497

(57) ABSTRACT

An anti-friction bearing, including a bearing ring (2), a bearing cage (5) for receiving at least one rolling body (4), a power supply unit (8) which is configured as a claw pole generator, wherein the claw pole generator (8) includes a first claw ring (10) with a sequence of first claws (11) and a second claw ring (12) which is offset in the circumferential direction of the bearing ring (2) and has a sequence of second claws, wherein the two claw rings (10, 12) surround an induction coil (9) encircling in the circumferential direction of the bearing ring (2), wherein the claws (11) of the two claw rings (10, 12) form, with a sequence of magnetic poles (14) encircling in the circumferential direction, magnetic circuits which surround the induction coil (9). The object of providing improved utilization of the installation space for receiving the claw pole generator for, in particular, two-row anti-friction bearings, specifically for self-aligning roller bearings, is solved according to the invention by virtue of the fact that the magnetic poles (14) are arranged on the bearing cage (5).

### BACKGROUND

The invention relates to a rolling bearing and a bearing arrangement for rotatably mounting a roller, in particular a guide roller for paper webs.

It is known from practice to generate electrical energy from the rotary movement of the rolling bearing during operation. For this, in particular rolling bearings are known in which an energy generation unit is structurally integrated. Specifically, rolling bearings are known in which the energy generation unit is in the form of a claw-pole generator. In this case, the claw-pole generator comprises a first claw ring with a series of first claws running in the circumferential direction of the rolling bearing, a second claw ring with a series of second claws running in the circumferential direction of the rolling bearing, an induction coil which is surrounded by the two claw rings and which encircles the axis of rotation of the rolling bearing, wherein the two claw rings are arranged offset with respect to one another in the circumferential direction. The claw-pole generator further comprises a series of magnetic poles running in the circumferential direction. If a first claw of the first claw ring is opposite a first pole, for example a north pole, a magnetic circuit is formed via a second claw which is adjacent in the circumferential direction, namely a claw of the second claw ring, to a second magnetic pole of different polarity which is adjacent in the circumferential direction, in this case a south pole, and this magnetic circuit surrounds the induction coil. If the bearing ring rotates further with the two claw rings, the second claw is opposite the north pole and the first claw is opposite a south pole, with the result that the direction of the magnetic circuit surrounding the induction coil is reversed and a magnetic potential is generated in the induction coil. Integrated in a rolling bearing, the two claw rings and the induction coil are fastened on one of the two bearing rings of the rolling bearing.

On rolling bearings with a power generation unit, in particular on rolling bearings with a claw-pole generator, experience has demonstrated the need for only a small additional installation space to be provided for the claw-pole generator or for existing installation space to be utilized such that the rolling bearing with the claw-pole generator deviates as little as possible from standard dimensions.

WO 2011/000362 A1 describes a rolling bearing in the form of a single-row ball bearing with a first bearing ring, a plurality of rolling elements which are guided by a bearing cage and an energy generation unit in the form of a claw-pole generator, wherein the claw-pole generator has a first claw ring with a series of first claws and a second claw ring with a series of second claws which is offset in the circumferential direction of the bearing ring, wherein the two claw rings surround an induction coil encircling in the circumferential direction of the first bearing ring, wherein the claws of the two claw rings with a series of magnetic poles encircling in the circumferential direction form magnetic circuits surrounding the induction coil. The two claw rings are in this case fastened on the first bearing ring with a magnetically conductive connection, and the magnetic poles are arranged on the second bearing ring of the rolling bearing such that the magnetic circuit surrounding the induction coil is closed by a magnetically conductive section of the first bearing ring. Precisely in the case of two-row or multiple-row rolling bearings, in particular for two-row self-aligning roller bearings, the installation space in the rolling bearing is not used optimally.

### SUMMARY

The object of the invention is to provide an improved use for in particular two-row rolling bearings, specifically for self-aligning roller bearings, of the installation space for receiving the claw-pole generator.

This object is achieved according to the invention for the rolling bearing mentioned at the outset in that the magnetic poles are arranged on the bearing cage.

Due to the relative movement of the bearing cage with the magnetic poles and bearing ring, on which the two claw rings with the induction coil are arranged, electrical energy can be generated, wherein the bearing cage receives magnetic poles and, in addition to the guidance of the rolling elements, is provided with an additional function.

The arrangement of the magnetic poles on the bearing cage is in particular suitable for two-row rolling bearings, i.e. rolling bearings with two rows of rolling elements, since there is an installation space between the two rows of rolling elements in which the two claw rings with the induction coil can be received in structurally integrated fashion, to be precise axially centrally between the end faces of the bearing ring, so that the rolling bearing only necessitates small changes to the connection means, for example in order to receive an electrical feed line of the induction coil.

Provision is preferably made for the magnetic poles to be connected to one another by a magnetically conductive magnetic return path ring. The magnetic return path ring provides the magnetic return path between magnetic poles of different polarity which are adjacent in the circumferential direction of the bearing cage and enables the integration of the claw-pole generator even in rolling bearings whose bearing cages are formed from a material which is not or only poorly magnetically conductive.

Preferably, provision is made for the magnetic poles to be received in a cage groove in the bearing cage. The magnetic poles received in the cage groove in, for example, countersunk fashion terminate flush with that face of the bearing cage which adjoins the cage groove, with the result that, for the induction coil which is opposite the magnetic poles, separated by the claws of the two claw rings and a gap, an enlarged installation space is available which can be used for increasing the fill factor of the induction coil, i.e. the number of turns of the electrical conductor of the induction coil.

Preferably, provision is made for two rows of rolling elements to be provided, for the bearing cage to comprise a central ring and for the magnetic poles to be arranged on the central ring of the bearing cage. The two rows of rolling elements are arranged on both sides of the central ring of the bearing cage, wherein the central ring encircles completely in circumferential direction, in particular uninterrupted by the pockets provided for receiving the rolling elements. The central ring is provided axially centrally between the two rows of rolling elements and is therefore opposite the interspace between the two races of the rolling elements on the bearing ring on the bearing ring, i.e. the point on the bearing ring which provides additional installation space for receiving the two claw rings and the induction coil.

Provision is preferably made for the rolling elements to be in the form of self-aligning rollers. The rolling bearing is in this case in the form of a two-row self-aligning roller bearing. The bearing cage of such a self-aligning roller bearing is often also referred to as “guide ring”. Self-aligning roller bearings can be provided for mounting large rollers, in particular in a bearing arrangement for rotatably mounting a guide roller for paper webs. In particular, provision can be made for a pressure sensor, in particular a piezoelectric pressure sensor, to be arranged on the lateral surface of the roller, wherein energy is supplied to the pressure sensor by the energy generation unit of the rolling bearing, in particular of the self-aligning roller bearing.

Provision is preferably made for the claw rings to be arranged in particular axially centrally on the bearing ring in a bearing ring groove. If in particular the rolling bearing is in the form of a two-row rolling bearing, specifically in the form of a two-row self-aligning roller bearing, provision is particularly preferably made for the bearing ring groove to be arranged axially centrally on the bearing ring. The bearing ring groove enlarges the installation space which is available for the induction coil.

Preferably, in respect of the bearing ring groove, provision is made for a substantially radially extending bore to be formed in a groove base of the bearing ring groove in the bearing ring. The bore assists with the alignment of the two claw rings relative to one another. The bore makes it possible to receive further electrical components which condition the AC voltage generated in the induction coil, in particular electronically rectify, smooth or possibly store said AC voltage. The bearing ring groove furthermore provides an enlarged resting face on which the claw ring can rest in magnetically conductive fashion in order to form a magnetically conductive connection to the bearing ring.

Preferably, in respect of the bore, provision is made for the bore to merge at one end with a substantially axially extending groove. Electrical lines are laid into the bore and supply power to the induction coil or the electronic components associated with the induction coil. The groove is substantially perpendicular to the bore, with the result that the positionally correct alignment of the composite comprising the two claw rings and the induction coil relative to the bearing ring can be ensured. A plug receptacle of a plug-type connection can be provided in the bore, into which plug receptacle a plug inserted in the groove is guided, with the result that a substantially rectangular plug-type connection is formed. The groove is preferably formed in a lateral surface of the bearing ring.

Provision is preferably provided for at least one of the claw rings to be formed so as to be split in the circumferential direction and for the at least one claw ring to be arranged in rotationally secure fashion in a receptacle receiving the induction coil. The claw ring which is split in the circumferential direction slots into a receptacle, within which the induction coil is received, wherein the receptacle has a depression on the outside, into which the partial claw ring fits. Particularly preferably, provision is made for each of the two claw rings to be split in half in the circumferential direction, wherein the respective half is received in a precise fit in the outer face of the receptacle, within which the induction coil is arranged. By virtue of the receptacle, the positionally correct alignment of the claw rings arranged offset in the circumferential direction is ensured.

Provision is preferably made for at least one of the two claw rings to be magnetically conductively connected to the bearing ring. This increases the installation space which is available in particular for the induction coil.

Further advantages and features result from the dependent claims and from the description below relating to a preferred exemplary embodiment of the invention.

### BRIEF DESCRIPTION OF THE DRAWINGS

The invention will be described and explained in more detail below with reference to the attached drawings.

FIG. 1 shows a partially sectioned view of an exemplary embodiment of a rolling bearing according to the invention in an exemplary embodiment of a bearing arrangement according to the invention, and

FIG. 2 shows the detail “Z” from FIG. 1 in an enlarged illustration.

### DETAILED DESCRIPTION OF THE PREFERRED EMBODIMENTS

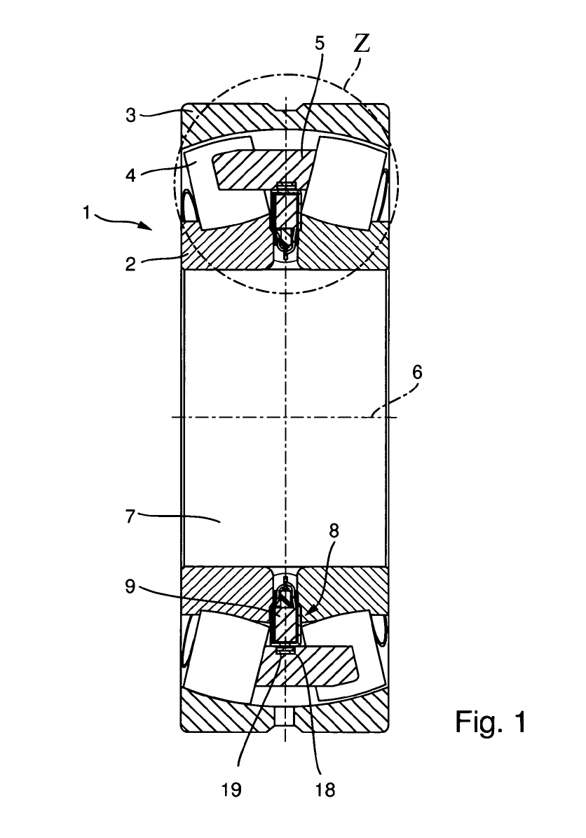

FIG. 1 shows a rolling bearing 1, which comprises a first bearing ring 2 and a second bearing ring 3. The rolling bearing 1 has two rows and comprises two rows of rolling elements 4, which are in the form of self-aligning rollers. The rolling elements 4 are guided by a bearing cage 5 in the circumferential direction, based on an axis of rotation 6 of the rolling bearing 1, and axially, i.e. substantially parallel to the axis of rotation 6 of the rolling bearing 1, and held spaced apart. The two rows of self-aligning rollers 4 are arranged offset with respect to one another in the circumferential direction.

The rolling bearing 1 is part of a bearing arrangement for rotatably mounting a roller, namely a guide roller for paper webs of a printing machine, wherein a conically tapering shaft 7 is held rotatably about the axis of rotation 6.

The guide roller has a pressure sensor, which detects the contact pressure of the paper web on the outer lateral surface of the roller, wherein the piezoelectric pressure sensor is provided on the lateral surface as a layer so as to encircle said lateral surface in helical fashion. Energy is supplied to the pressure sensor by the rolling bearing 1. For this, the rolling bearing 1 comprises an energy supply unit 8. The energy supply unit 8 is in the form of a claw-pole generator and comprises an induction coil 9 which encircles in the circumferential direction, in particular encircles the axis of rotation 6.

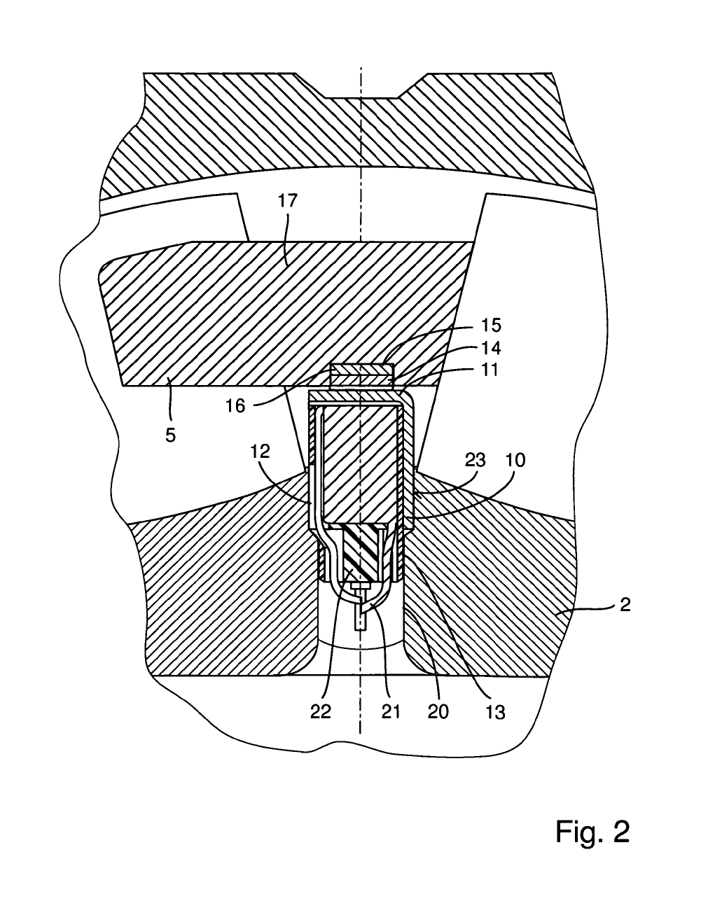

FIG. 2 shows the claw-pole generator in an enlarged illustration.

The claw-pole generator 8 comprises a first claw ring 10, which comprises a series of first claws encircling in the circumferential direction, based on the axis of rotation 6, wherein one of the first claws is denoted by the reference symbol 11. The first claw 11 is in the form of a section of the ring-shaped radially extending first claw ring 10, which section is set at an angle substantially axially, i.e. parallel to the axis of rotation 6.

The claw-pole generator 8 comprises a second claw ring 12 with a series of second claws running in the circumferential direction, wherein the section plane of the illustration in FIG. 2 is set such that a first of the second claws is arranged above the paper plane and a second of the second claws which is adjacent in the circumferential direction is arranged below the paper plane. The section plane of the illustration in FIG. 2 passes through the second claw ring 12 in the region of the radially extending ring-shaped section. The two unidentifiable second claws of the second claw ring 12 are directed axially, i.e. parallel to the axis of rotation 6, similarly to the first claw 11 of the first claw ring 10.

The two claw rings 10, 12 of the claw-pole generator 8 surround the induction coil 9, which is arranged in a receptacle 13 which surrounds the induction coil 9 on four sides. The receptacle 13 is formed from a magnetically nonconductive material, namely an injection-moldable plastic, and is in the form of a hollow ring which is open on the inside with a substantially U-shaped cross section, wherein the induction coil 9 is received between the limbs of the U and structuring with a depression is provided on the outside on the two limbs of the U. The second claw ring 12 is inserted into the respective depression in such a way that the second claw ring 12 terminates substantially flush with that outer face of the receptacle 13 which adjoins the depression. The first claw ring 10 is likewise inserted into a depression in the outer face of the receptacle 13.

The induction coil denoted by the reference symbol 9 has, in addition to a metallic conductor which surrounds the axis of rotation 6 with a plurality of turns, an electrically conductive casting compound, with the result that a dimensionally stable composite is produced which can be inserted as induction coil 9 into the receptacle 13, namely the opening of the U. The claws of the two claw rings 10, 12 cover the opening of the U and prevent the induction coil 9 from falling out of the receptacle 13.

The claw-pole generator further comprises a series of magnetic poles encircling in the circumferential direction, namely the axis of rotation 6, said magnetic poles being denoted by the reference symbol 14. Adjacent poles are in this case of different polarity; for example the magnetic pole 14 is a north pole and the respectively adjacent magnetic pole located above or below the paper plane is a south pole. The magnetic poles 14 are in this case sections of plate-shaped permanent magnets which, arranged alternately in the circumferential direction, are aligned in such a way that in each case one pole points in the direction of the axis of rotation 6 and therefore in the direction towards a claw of one of the two claw rings 10, 12.

The two claw rings 10, 12 are arranged offset with respect to one another in the circumferential direction in such a way that, for example, all of the first claws 11 of the first claw ring 10 are opposite a north pole 14 and all of the second claws of the second claw ring 12 are opposite a south pole.

The two claw rings 10, 12 rest directly against the magnetically conductive material of the body of the first bearing ring 2, with the result that the two claw rings 10, 12 are magnetically conductively connected to the bearing ring 2.

Thus, a magnetic circuit encircling the induction coil 9 and the electrically conductive turns received there is formed, starting from the first magnetic pole 14 in the form of a north pole, via a gap, to the first claw 11 of the first claw ring 10, via the magnetically conductive material of the body of the first bearing ring 2, to the second claw ring 12, to one of the second claws of the second claw ring 12 via the gap to a magnetic pole in the form of a south pole, which is adjacent to the magnetic pole 14 in the form of a north pole in the circumferential direction. On rotation of the bearing ring 2 about the axis of rotation, the orientation of the magnetic circuit changes, with the result that an AC voltage is induced in the turns of the electrical conductor in the induction coil 9, said AC voltage being tapped off as useful voltage, in particular after electronic conditioning.

The magnetic poles of the claw-pole generator 8, in particular also the north pole denoted by the reference symbol 14, are arranged on the bearing cage 5 of the rolling bearing 1. During operation of the rolling bearing 1, the shaft 7 and the first bearing ring 2 of the rolling bearing which is fastened on the shaft 7 rotate about the axis of rotation 6. In the process, the bearing cage 5 guides the magnetic poles around the axis of rotation 6 with a lower rotation speed deviating from the rotation speed of the first bearing ring 2, with the result that, owing to the difference in rotation speed between the first bearing ring 2 and the bearing cage 5, a relative movement of the magnetic poles 14 with respect to the claws 11 of the two claw rings 10, 12 occurs and an AC voltage is induced in the induction coil 9.

The magnetic poles including the north pole denoted by the reference symbol 14 are magnetically conductively connected to one another by a magnetic return path ring 15. The magnetic return path ring 15 is formed of a magnetically conductive material such as a rolling bearing steel or iron or another ferromagnetic material and is formed as a strip which is fastened on the bearing cage 5, encircling said bearing cage in the circumferential direction. The permanent magnets are fastened with the poles pointing away from the claws 11 on the magnetic return path ring 15, for example are inserted or are fastened by means of a magnetically conductive adhesive layer. The permanent magnets are arranged in a holding ring, which extends in the circumferential direction along the bearing cage 5 and is fixed in plug-type receptacles in the holding ring. The holding ring is formed of a material with poor magnetic conductivity, such as brass, for example, and serves to fix and space apart the permanent magnets.

The magnetic poles including the north pole denoted by the reference symbol 14 are arranged in a cage groove 16 in the bearing cage 5 and received in the cage groove 16 in such a way that the cage groove 16 is filled by the magnetic return path ring 15 and the permanent magnets, received in the brass holding ring, with the magnetic poles 14, and the poles 14 terminate flush with that face of the bearing cage 5 which adjoins the cage groove 16.

The bearing cage 5 comprises a central ring 17, with the pockets on both sides of said central ring being arranged as receptacles for the two rows of rolling elements 4, with the result that the central ring 17 encircles the axis of rotation 6 uninterrupted. The magnetic poles including the north pole denoted by the reference symbol 14 are arranged on the central ring 17, to be precise in the cage groove 16, which is provided in the region of the central ring 17 as a portion of weakened material which is acceptable for the stability of the bearing cage 5.

The two claw rings 10, 12 are arranged on the first bearing ring 2 in a bearing ring groove 18, to be precise sectionally received in countersunk fashion in the bearing ring groove 18. The bearing ring groove 18 extending in the circumferential direction (FIG. 1) is arranged axially centrally between the two end faces of the first bearing ring 2 and encircles the axis of rotation 6. The bearing ring groove 18 has a substantially rectangular cross section, which receives the base and the lower sections of the limbs of the U-shaped receptacle 13, within which the induction coil 9 is arranged. The bearing ring groove 18 is arranged centrally between the two races of the self-aligning roller rows.

The bearing ring groove 18 forms groove flanks 23, on which the claw rings 10, 12 rest sectionally in close magnetically conductive contact, with the result that the magnetic contact resistance of the magnetic circuit is reduced at this point. In this case, the two claw rings 10, 12 are directly magnetically conductively connected to the first bearing ring 2, with the result that there is no magnetically conductive adhesive layer between the claw ring 10, 12 and the magnetically conductive section of the body of the first bearing ring 2 and the installation space to be provided for the adhesive layer can be saved.

The claw rings 10, 12 are in the form of lamination blanks which are substantially in the form of circular rings and have radially extending sections consisting of a magnetically conductive material, in which the radial sections forming the claws 11 are set at an angle substantially perpendicular to the plane of the lamination blank.

The bearing ring groove 18 forms a substantially flat groove base 19 (FIG. 1), from which, at one point, namely in the region of the section plane of the illustration in FIG. 2, a bore 20 is formed which extends radially perpendicular to the groove base 19. Electrical feed lines 21 to the turns of the induction coil 9 are received in the bore 20, wherein the receptacle 13 for the feed lines 21 is sectionally interrupted. Furthermore, electronic components 22 are received in the bore 20, said electronic components serving to electronically condition the AC voltage of the induction coil 9, in particular to rectify and smooth said AC voltage, and possibly to store the generated energy in an energy store.

At one end, the bore 20 merges with a groove which extends substantially axially, i.e. parallel to the axis of rotation 6 (FIG. 1), i.e. deviates through approximately 90°. This groove (which is not illustrated figuratively in FIG. 2) serves to pass the voltage and energy generated by the claw-pole generator 8 out. An electrical line is introduced into this groove, which is formed on that lateral surface of the first bearing ring 2 which points toward the shaft 7, said electrical line forming a 90° plug with the connection provided in the bore 20, said plug serving to correctly position the first bearing ring 2 with the induction coil 9 and the two claw rings 10, 12 in relation to the shaft 7.

In the above-described exemplary embodiment, provision has been made for the induction coil 9, the two claw rings 10, 12 and the claws 11 to be fastened on the first bearing ring 2 which is rotationally fixed on the shaft 7 and rotates with the shaft 7. As an alternative to this, provision can be made for the induction coil 7 and the two claw rings 10, 12 with the claws 11 to be arranged on the fixed, second bearing ring 3.

In the above-described exemplary embodiment, provision has been made for electronic components 22 which rectify, stabilize or smooth the AC voltage induced in the electrically conductive turns of the induction coil 9 or store the energy generated, for example, to be arranged in the bore 20, but outside the receptacle 13 of the induction coil 9. Alternatively, provision can be made for the electronic components 22 to be arranged outside the bore 22, in particular also physically separately from the rolling bearing 1. In turn, as an alternative, provision can be made for the electronic components to be arranged within the bore 22 and within the receptacle 13, on the base of the U profile of the receptacle 13.

The invention has been described above with reference to an exemplary embodiment, in which the rolling bearing was in the form of a self-aligning roller bearing with self-aligning rollers as rolling elements 4. It goes without saying that other rolling elements can also be provided; the rolling bearing 1 can in particular also be in the form of an angular contact ball bearing or in the form of a tapered roller bearing or in the form of a cylindrical roller bearing (in particular with two or more rows). It furthermore goes without saying that the rolling bearing 1 is also in the form of a single-row rolling bearing, wherein the bearing cage 5 does not have a central ring 17 and the magnetic poles 14 of the permanent magnets can be arranged on the bearing cage, for example on the end face of the bearing cage or on a lateral surface close to the end face of this bearing cage.

In the above-described exemplary embodiment, rolling elements 4 were guided by the bearing cage 5 in the rolling bearing 1, i.e. were cage-guided. It goes without saying that other guidance of the bearing cage can also be provided, in particular the bearing cage 5 can also be designed to be deck-guided such that the bearing cage 5, for example in the region of the central ring 17, has a contact section with respect to the race of the second bearing ring 3, wherein the contact section ensures, to a particular degree, that a gap of a constant width is maintained between the magnetic poles 14 and the claws 11 of the two claw rings 10, 12.

### LIST OF REFERENCE SYMBOLS

1 rolling bearing
2 first bearing ring
3 second bearing ring
4 rolling element
5 bearing cage
6 axis of rotation
7 shaft
8 energy supply unit
9 induction coil
10 first claw ring
11 first claw
12 second claw ring
13 receptacle
14 magnetic pole
15 magnetic return path ring
16 cage groove
17 central ring
18 bearing ring groove
19 groove base
20 bore
21 feed line
22 electronic component
23 groove flank

1. A rolling bearing, comprising:
a bearing ring,
a bearing cage that receives at least one rolling element,
an energy supply unit comprising a claw-pole generator, the claw-pole generator comprises a first claw ring with a series of first claws and a second claw ring with a series of second claws, said second claw ring is offset in a circumferential direction of the bearing ring, the two claw rings surround an induction coil encircling in the circumferential direction of the bearing ring,
the claws of the two claw rings include a series of magnetic poles encircling in the circumferential direction that form magnetic circuits surrounding the induction coil, and
the magnetic poles are arranged on the bearing cage.

2. The rolling bearing as claimed in claim 1, wherein the magnetic poles are connected to one another by a magnetically conductive magnetic return path ring.

3. The rolling bearing as claimed in claim 1, wherein the magnetic poles are received in a cage groove in the bearing cage.

4. The rolling bearing as claimed in claim 1, wherein two rows of rolling elements are provided, the bearing cage comprises a central ring, and the magnetic poles are arranged on the central ring of the bearing cage.

5. The rolling bearing as claimed in claim 4, wherein the rolling elements are self-aligning rollers.

6. The rolling bearing as claimed in claim 1, wherein the claw rings are arranged axially centrally on the bearing ring in a bearing ring groove.

7. The rolling bearing as claimed in claim 6, wherein a substantially radially extending bore is formed in a groove base of the bearing ring groove in the bearing ring.

8. The rolling bearing as claimed in claim 7, wherein the bore merges at one end with a substantially axially extending groove.

9. The rolling bearing as claimed in claim 1, wherein at least one of the claw rings is formed split in the circumferential direction, and the at least one claw ring is arranged in rotationally secure fashion in a receptacle receiving the induction coil.

10. The rolling bearing as claimed in claim 1, wherein at least one of the two claw rings is magnetically conductively connected to the bearing ring.

11. A bearing arrangement for rotatably mounting a roller, including a rolling bearing as claimed in claim 1.

12. The bearing arrangement as claimed in claim 11, further comprising a pressure sensor on a lateral surface of the roller, and energy is supplied to the pressure sensor by the energy supply unit of the rolling bearing.

13. The bearing arrangement of claim 12, wherein the pressure sensor is a piezoelectric pressure sensor.
